(19) United States
(12) Patent Application Publication
(10) Pub. No.: US 2010/0290981 A1
(43) Pub. Date: Nov. 18, 2010

(54) MONOLITHIC CATALYST AND USES THEREOF

(75) Inventor: Gil Katz, Haifa (IL)

Correspondence Address: THE NATH LAW GROUP, 112 South West Street, Alexandria, VA, 22314, US

(73) Assignee: HYDROGEN CATALYST LTD., D.n. Emek Hefer (IL)

(21) Appl. No.: 12/812,710

(22) PCT Filed: Jan. 5, 2009
(86) PCT No.: PCT/IL09/00017

§ 371 Date: Jul. 13, 2010

Related U.S. Application Data
(60) Provisional application No. 61/006,435, filed on Jan. 14, 2008.

(51) Int. Cl. B01J 23/26; C01B 3/26; B01J 23/06

(52) U.S. Cl. 423/651; 502/315; 502/307

(57) ABSTRACT

A monolithic and non-supported catalyst composition for use in a variety of chemical transformations is provided. Further provided is a process for the catalytic transformation of an organic compound, as well as a process for the catalytic decomposition of a hydrocarbon.

### FIELD OF THE INVENTION

This invention relates to a monolithic non-porous recyclable metal catalyst and uses thereof, e.g., in the direct decomposition of methane gas into hydrogen gas.

### BACKGROUND OF THE INVENTION

Catalysts are wildly used in a verity of chemical reactions. Reactions with high activation energy that normally are too slow or would not take place in the absence of a catalyst are promoted by catalysis. The catalyst functions by increasing the rate of one or more steps in the reaction mechanism by providing a reaction path having lower activation energy. Interestingly, the presence of a relatively small amount of catalyst is typically required to significantly influence the speed of the reaction.

Metals and/or metal-containing compounds are well known substances which exhibit catalytic power to a great degree. U.S. Pat. No. 6,875,417 to Shah et al. [1] discloses novel alumina-supported metal catalysts for accomplishing catalytic decomposition of undiluted light hydrocarbons to a substantially carbon dioxide-free hydrogen product and a valuable multi-walled carbon nanotube co-product.

Non-oxidative catalytic dissociation of methane and other hydrocarbons is an environmentally attractive approach to carbon dioxide-free production of hydrogen [2]. A major drawback of such reaction, however, is the formation of solid carbon which deposits from the gas-phase hydrocarbon and may hence cause sever fouling of the reactor, catalyst, and gas handling system [3]. In fact, attempts to recover the catalyst from the contaminating carbon product is reported to also involve the production of undesired carbon dioxide.

The usage of activated carbon catalysts in the non-oxidative decomposition of methane for carbon dioxide-free hydrogen has also been demonstrated [4,5].

### REFERENCES

[1] U.S. Pat. No. 6,875,417;
[2] Nazim Muradov et al., “Catalytic dissociation of hydrocarbons: a route to CO₂-free Hydrogen”; Florida Solar energy Center, University of Central Florida, Cocoa, Fla. 32922. USA.
[3] Shankang Ma et al, “Catalytic Methane decomposition using a fluidized bed reactor for hydrogen production”. Am. Chem. Soc. Div. Fuel Chem. 2005, 50(2), 636.
[4] Korean J. Chem. Eng., 20(5), 835-839 (2003), Myung Hwan Kim et al, “Hydrogen Production by Catalytic decomposition over Activated carbons: Deactivation study”.
[5] Proceeding International Hydrogen Energy Congress and Exhibition IHEC 2005. Kang Kyu Lee et al, “Hydrogen production by catalytic decomposition of Methane over Carbon catalysts in fluidized bed”.

### SUMMARY OF THE INVENTION

With the great increase in recent years in the production of greenhouse gases, there have been ongoing efforts to manufacture generic catalyst compositions for the decomposition of hydrocarbons, such as methane, and their conversion into other more beneficial and safer materials.

This application discloses the inventor's successful approach to the preparation of a family of such catalysts. The catalyst compositions of the invention comprise metals and/or oxide forms thereof with uses beneficial to a “greener” environmental and friendly chemistry and with potential applicability in many industrial fields.

The catalyst disclosed herein may be characterized by being one or more of the following:

1. monolithic and non-porous;

2. requires no support matrix for efficient conversion;

3. stable at any working temperature;

4. efficient in catalytic decomposition of hydrocarbons;

5. made reusable by mechanical and/or chemical removal of deposited carbon; and

6. allows the direct decomposition of methane into hydrogen gas and solid carbon only, with a selectivity being equal to 1, namely no further contaminating decomposition products such as carbon dioxide or hydrocarbons are produced during the decomposition process.

A person skilled in the art would appreciate the importance of such a catalyst in the green transformation of natural or industrially produced materials such as hydrocarbons, e.g., in the gas phase, which volume, both from natural and industrial sources, requires the use of efficient, reusable and green catalysts that would reduce the costs associated with capital investment and operating cost of the large volume conversion into clean and usable hydrogen gas. The catalyst of the present invention has demonstrated such characteristics, allowing its classification as a green catalyst for environmentally safe use.

Thus, in one aspect of the present invention there is provided a catalyst composition comprising at least one metal or metal oxide selected from Co⁰, Ni⁰, Cr⁰ and Cr₂O₃, said catalyst composition being monolithic and non-supported.

In some embodiments of the invention, the catalyst composition may further comprise at least one of the metals or metal oxides selected from Mo⁰, Fe⁰, Mn⁰, MnO₂, Pt⁰, Pd⁰, V⁰, V₂O₅, Cd⁰, Ag⁰, Zn⁰, ZnO, and Cu⁰.

Within the scope of the present invention, the designation of a metal element as having a charge of zero, for example in the case of Co⁰, means a metal element in a non-oxidized form. As some metal elements may be sensitive to oxidation particularly when exposed to oxidizing agents, e.g., oxygen, the catalyst composition may be treated, as will be demonstrated further below, prior to use with an appropriate reducing agent under appropriate conditions in order to revert the oxidized form of the metal components into their non-oxidized elemental form.

The catalyst composition of the invention is characterized as being “monolithic” namely being a single mass substantially free of any micro-, mesa- or macro-sized pores and exhibits no deterioration (by way of physical dissociation or erosion) during reaction and recycling. Surface analysis of the catalyst of the invention, for example by employing visual methods (e.g., metallographic techniques) provides evidence of such monolithic character. The catalyst composition of the invention is also “non-supported”, namely the composition of the metal/oxides is not mixed or deposited on any inert supporting matrix such as alumina or carbon which is typically employed to provide a larger contact area for the catalytic process.

As used herein, specified percentages (%) of metals or metal oxides are given in w/w (weight per weight) unless otherwise indicated.

The catalyst composition of the invention comprises, in some embodiments, between about 5-60% Co⁰, between about 10-90% Ni⁰, between about 1-45% Cr⁰ and between about 1-45% Cr₂O₃, weight/weight (w/w). The catalyst composition may further comprise at least one metals or metal oxides selected from Mo⁰, Fe⁰, Mn⁰, MnO₂, Pt⁰, Pd⁰, V⁰, V₂O₅, Cd⁰, Ag⁰, Zn⁰, ZnO, and Cu⁰ in amounts ranging from between about 0-20% (w/w).

In some further embodiments, the catalyst composition comprises between about 5-15% Co⁰, between about 15-90% Ni⁰, between about 1-35% Cr⁰ and between about 1-35% Cr₂O₃ (w/w). In additional embodiments, the catalyst composition comprises between about 5-15% Co⁰, between about 15-90% Ni⁰, between about 1-15% Cr⁰ and between about 1-15% Cr₂O₃ (w/w). In these embodiment, the catalyst composition may further comprise at least one metal or metal oxide selected from Mo⁰, Fe⁰, Mn⁰, MnO₂, Pt⁰, Pd⁰, V⁰, V₂O₅, Cd⁰, Ag⁰, Zn⁰, ZnO, and Cu⁰ in amounts ranging from between about 0.5-18% (w/w).

In yet other embodiments, the catalyst composition comprises a minimum of about 5% Co⁰, a minimum of about 50% Ni⁰, minimum of about 1% Cr⁰ and a minimum of about 1% Cr₂O₃ (w/w). The catalyst composition may further comprise at least one metal or metal oxide as disclosed above.

As a person skilled in the art would realize, the amount or concentration of each of the metal/metal oxides employed in the actual catalyst composition may vary depending inter alia on the chemical transformation to be achieved, the percent conversion sought and the desired single or plurality of products. Therefore, any specific amount/concentration of metal/metal oxide provided herein should be taken to mean an approximate amount/concentration. For example, the expression “between about 15-90% Ni⁰” refers to a (w/w) Ni⁰ concentration which is may be slightly below or slightly above or within the indicated range. For example, the range 15-90% would mean 14.5, 14.6, 14.7, 14.8, 14.9, 15.0, 15.1, 15.2, 15.3, 15.4, 15.5 and so on to 89.0, 89.1, 89.2, 89.3, 89.4, 89.5, 89.6, 89.7, 89.8, 89.9, 90.0, 90.1, 90.2, 90.3, 90.4, 90.5% of the total weight of the composition. Any equivalent amounts are within the scope of the present invention.

In some embodiments, the catalyst composition is reusable (also recyclable), namely a quantity of the catalyst used in a first catalytic reaction may be re-used in a second or further catalytic reaction after isolation from the reaction vessel or reactor in which said first catalytic reaction has taken place. The catalyst composition may be used sequentially, or may be isolated from the reactor of the first reaction or any further reaction and stored for future use. The isolation of the catalyst composition from the reactor of said first catalytic reaction may require a regeneration step or isolation of the catalyst from possible contaminants which may be present, e.g., solid carbon.

The catalyst composition of the invention may be prepared by mixing together selected weighted portions of the individual metals or metal oxides to a final quantity which is then heated to afford a metal mass (a solid composition) which may then be employed as such or reduced in size. The catalyst composition may also be prepared by granulating the metal/metal oxide components and sintering the mass as explained hereinbelow.

Without wishing to be bound by theory or any one mechanistic description, catalysts are used by those skilled in the art to lower the activation energy of a chemical reaction, and thereby promote it. Under such transformations, the catalyst is used in non-equivalent amounts and in itself does not undergo any permanent chemical change. The catalyst composition of the invention may be used for the catalytic transformation of various compounds, organic (containing at least one carbon atom) or inorganic. The compound to be chemically transformed in a catalytic reaction in the presence of a catalyst composition according to the invention may be any compound at any physical state, namely solid, liquid or gas which transformation is sought.

Generally, the catalytic reaction is carried out by contacting the compound to be transformed, e.g., decomposed, with a catalyst composition. As used herein, the term “contacting” refers to the bringing together of the compound and the catalyst (and any other reactant which may be present) in such a way to allow intimate contact between them. The contacting may be, for example, by flowing a gas, which may be the compound to be transformed or comprising the compound to be transformed, over or through the catalyst composition or a matrix (medium) containing thereof, by dissolving the compound in a suspension of a catalyst, etc.

In some cases, the transformation may be carried out by flowing a stream of gas over the catalyst composition under conditions allowing such transformation. In some other cases, the transformation may be carried out in a solution, where the compound to be transformed is dissolved or suspended in a solvent where the catalyst is present.

Thus, the present invention also provides a use of a catalyst composition as defined herein for the catalysis of a chemical reaction. In some embodiments, the chemical reaction is an organic reaction. In some other embodiments, the chemical reaction is an inorganic reaction.

In some embodiments, the organic reaction is selected amongst catalytic organic reactions which involve bond formations (single, double or triple bond formation) between at least one carbon atom and at least one other atom (which may or may not also be a carbon atom) and/or bond cleavage (of a single, a double or a triple bond) between at least one carbon atom and another atom (which may or may not also be a carbon atom).

In some further embodiments, the organic reaction is selected from oxidation, hydrogenation, carbonylation, carbon-carbon bond formation, metathesis, decomposition of hydrocarbons and polymerization.

In further embodiments, the organic reaction involves decomposition of a hydrocarbon into hydrogen, wherein said hydrocarbon is selected amongst hydrocarbons having between 1 and 15 carbon atoms. As used herein, a “hydrocarbon” is an organic compound composed entirely of hydrogen and carbon atoms. Non-limiting examples of such hydrocarbons are straight chain or branched alkanes such as methane, ethane, propane, iso-propane, heptane and others.

In some embodiments, the hydrocarbon is selected amongst hydrocarbons being gases at ambient. In some embodiments, the hydrocarbon is selected amongst hydrocarbons having a boiling point at around or below room temperature.

In some embodiments, the hydrocarbon is methane.

In some embodiments, the process employs a combination of a catalyst composition of the invention with at least one additional catalyst as known in the art. The use of a combination of catalysts may be beneficial in achieving a multi-step catalytic process in which each of the steps may be catalyzed by a different catalyst. At least one stage of this multi-step catalytic process is catalyzed by at least one catalyst composition of the present invention.

In another aspect, the present invention provides a process for the catalytic transformation of a first compound, in some embodiments a first organic compound, said transformation being selected from oxidation, hydrogenation, carbonylation, carbon-carbon bond formation, metathesis, decomposition of hydrocarbons (e.g., involving or following bond breaking) and polymerization, said process comprising contacting said first (e.g., organic) compound with a catalyst composition in a reaction vessel (e.g., a reactor, under conditions allowing said transformation), thereby obtaining a second compound, i.e., a product which is obtained by transformation of said first compound by one or more of oxidation, hydrogenation, carbonylation, carbon-carbon bond formation, metathesis, decomposition of hydrocarbons and polymerization.

As used in this process, the first compound, which may or may not be an organic compound, is the compound which chemical transformation is sought. The conditions which allow such transformation may include the application of conditions different from ambient, such as a high temperature and a pressure above or below atmospheric pressure. In some instances, depending on the chemical transformation to be achieved, the reaction may require the addition of at least one reactant, being different from the first compound, so that the first compound and said at least one reactant interact (react) under the conditions employed and in the presence of the catalyst composition to afford the second compound, a product. One such example is the hydrogenation of an olefin (alkene having at least one double bond) in the presence of hydrogen gas.

The second compound is typically the product which is derived from the chemical transformation. However, as a person skilled in the art would realize, the product may be one of a mixture of compounds resulting from, e.g., the decomposition of the first compound or of any one or more reactants present in the reaction mixture. The product, being a single product of decomposition or a mixture of products may be organic or inorganic independent of the nature of the first compound.

The process of the invention may thus further comprise the step of isolating and optionally purifying said product(s) from any other component or impurity which may be present in the mixture in which it was produced.

In some instances, said product is in fact a mixture of compounds whose concomitant preparation is possible. Thus, in some embodiments, said product is a mixture of two or more compounds. The mixture may be of compounds at the same physical state or compounds at different states, such as gas and solid. Where separation of the individual compounds is required, the process may involve additional steps of isolation and purification of each of the compounds.

In some embodiments, the process of the invention is used for the decomposition of a hydrocarbon, said hydrocarbon being selected amongst hydrocarbons having a between 1 and 15 carbon atoms, said process comprises contacting a hydrocarbon with a catalyst composition in a reaction vessel (a reactor) under conditions allowing said decomposition, thereby obtaining a product.

In some embodiments, the above-mentioned process optionally further comprises the step of recovering the organic compound or of any other compound which may result from said decomposition (organic or inorganic, at any physical state).

In another aspect of the invention, there is provided a process for the decomposition of methane gas, said process comprising flowing methane gas over and/or through a catalyst composition according to the invention under conditions allowing the decomposition of said methane gas into hydrogen gas and solid carbon, thereby allowing the production of solid carbon and hydrogen gas, being substantially free of carbon dioxide.

As a person skilled in the art would appreciate, the catalyst of the invention affords means to convert methane gas into hydrogen gas in a single step. Thus far, such a conversion has been achieved employing two-step or multi-step processes or processes having varying yields of conversion. Despite the fact that some of the methods of conversion currently employed in the industry are beneficial in converting methane into hydrogen gas, such methods are clearly un-green, relatively expensive and require a great deal of processing both in the conversion itself and the purification of the hydrogen gas from several components including water vapors. In contradiction, the process of the invention, making use of a catalyst of the invention allows the clean, environmentally safe and efficient conversion of methane directly into hydrogen gas.

Typically, the one-step conversion employing a catalyst of the invention affords hydrogen gas in amounts which are stoichiometrically equivalent to between at least 4% and 80% conversion of methane to hydrogen.

Once produced, the evolved hydrogen gas may be allowed to flow from the reaction vessel (a reactor) into an external gas treatment unit (a gas separation unit being in gas communication with said reaction vessel) where it is separated and the non-converted methane is recycled back to the reactor. The clean hydrogen stream may be used as a feed for other processes/reactions and/or may be stored in cylinders or special containers for transport or future use.

The solid carbon resulting from the decomposition of the hydrocarbon typically settles in the reaction vessel and may collect also on the surface of the catalyst. The separation of the solid carbon from the catalyst composition is required so as to enable further use of the catalyst composition. This separation may be achieved by exposing the solid mass comprising the catalyst and the carbon to one or more of the following procedures:

1. ultrasonication of the solid mass so as to allow dissociation of the carbon from the catalyst composition;

2. treatment of the solid mass with a solvent mixture comprising at least one carbon-removing solvent;

3. treatment of the solid mass with a solvent mixture comprising at least one surfactant;

4. treatment of the solid mass with an aqueous solution with or without a surfactant;

5. washing the solid mass with a solvent (such as water) to remove and filter out suspended fine particles;

6. centrifuging the solid mass in the presence of a liquid to separate the liquid with the fine carbon particles from the solid catalyst composition;

7. separating the solid mass and liquids carrying fine carbon particles by cyclone separation; and/or

8. mechanically rubbing the solid mass in the presence or absence of a solvent to remove carbon particles from solid mass.

The process for the production of hydrogen gas from a hydrocarbon comprises reacting a hydrocarbon with a catalyst composition according to the invention and allowing said hydrocarbon to decompose into hydrogen. The hydrocarbon may be any hydrocarbon which decomposition affords hydrogen along with a single carbon-based product or in a mixture with a plurality of such carbon-based products. In some embodiments, the hydrocarbon is methane.

In some embodiments of the catalytic process of the invention, the methane (or otherwise a hydrocarbon) is passed through said reaction vessel (a reactor) at a temperature below its chemical decomposition temperature. In some embodiments, the temperature is from about 400° C. to about 825° C. In yet further embodiments, the methane (or otherwise a hydrocarbon) is passed through said reactor at a temperature of from about 550° C. to about 775° C.

As used herein, the term “reaction vessel”, “reaction chamber”, “reactor” or any alternative term used interchangeably refers to a device for carrying a catalytic reaction. Typically, such a device may be of any size, shape and constructed of any material suitable for high pressure and high temperature conversions.

In some embodiments, the reactor is in the shape of a pipe or a tank. In other embodiments, the reactor is selected from: a fixed bed reactor (a reactor in which the catalyst is held in place and does not move with respect to a fixed reference frame, e.g., a catalyst bed), a moving bed, a fluidized bed reactor (FBR—a reactor device in which the methane gas is passed through a catalyst at high enough velocities to suspend the solid and cause it to behave as though it were a fluid) and a circulating fluidized bed reactor.

In some embodiments, the reactor is at least one reactor in an arrangement of reactors.

The invention further provides a reusable monolithic metallic (namely, containing metal and/or metal oxides) catalyst composition for converting methane gas into hydrogen gas.

In some embodiments, said reusable monolithic metallic catalyst is a catalyst composition comprising at least one metal or metal oxide selected from Co⁰, Ni⁰, Cr₂O₃, Mo⁰, Fe⁰, Mn⁰, MnO₂, Pt⁰, Pd⁰, V⁰, V₂O₅, Cd⁰, Ag⁰, Zn⁰, ZnO, Cr⁰, and Cu⁰.

The invention further provides, in another of its aspects, the use of said reusable monolithic metallic catalyst composition in the chemical transformation of a compound as disclosed herein.

As used herein, the singular form “a”, “an” and “the” include plural references unless the context clearly dictates otherwise. For example, the term “a metal” or “at least one metal” may independently include a plurality of metals, including mixtures thereof.

It is appreciated that certain features of the invention, which are, for clarity, described in the context of separate embodiments, may also be provided in combination in a single embodiment. Conversely, various features of the invention, which are, for brevity, described in the context of a single or a group of embodiments, may also be provided separately or in any suitable sub-combination or as suitable in any other described embodiment of the invention. Certain features described in the context of various embodiments are not to be considered essential features of those embodiments, unless the embodiment is inoperative without those elements.

### BRIEF DESCRIPTION OF THE DRAWINGS

In order to understand the invention and to see how it may be carried out in practice, embodiments will now be described, by way of non-limiting example only, with reference to the accompanying drawing, in which:

FIG. 1 is a block diagram of a non-limiting example of a process of the invention.

### DETAILED DESCRIPTION OF EMBODIMENTS

Various embodiments and aspects of the present invention as delineated hereinabove and as claimed in the claims section below find experimental support in the following examples.

### Catalyst Preparation:

The catalyst composition was prepared in three different ways as exemplified below:

### Example 1

Selected portions (in a particle form and or as large pieces) of the individual metals or metal oxides were weighed. The desired final quanta were inserted into an alumina cup or a high temperature holder. The metals/metal oxides were melted in an induction heater or under a high temperature torch such as acetylene-oxygen direct and by indirect heating or electric arc furnace. Thereafter, the metals/metal oxides were mixed. The stirred melt was poured into a grove in a metal block typically of magnesium oxide and cooled down to room temperature. The metal bar was extracted out of the block, cleaned from external foreign materials, and crashed with a crashing milling machine to the desire particle sizes, in the range of 50-1,000 micrometer. The metal particles were screened to the desired mesh fraction, washed with acetone, methyl ethyl ketone (MEK) or another suitable solvent and thoroughly dried. In some cases, the resulting catalyst particles were sintered under a gradient temperature ranging from 750 and 900° C. over a one-hour period and rapidly cooled down by N₂.

### Example 2

Metals/metal oxides of the desired particle size in the range of 100-500 micrometer were prepared or obtained commercially. The metal particles were washed with acetone or MEK and dried thoroughly. The granular metals/metal oxides of the desired final quanta were mixed and brought to an averaged size uniformity, e.g., in the range of 250-350 micrometer. The mixture was pressed with a press device having no less than 10 kg/cm² pressure, to the desired size, e.g., 1 cm³, 2 cm³. The large pressed granules were placed in an oven and sintered at 700-900° C. followed by quick cooling under a stream of nitrogen gas.

### Example 3

Metals/metal oxides in a solution form were selected or solutions were prepared by dissolving the metals/metal oxides in nitric acid or an equivalent acid. The desired metal percentage in the final composition was calculated and the solution was mixed thoroughly. The water and part of the acids were evaporated by moderate heating, resulting in a liquid concentrate having muddy appearance. The concentrate was stirred and cooled to 40° C. Distilled water at 3-4 volume parts of water to 1 part of concentrate were added. Concentrated NH₄OH was added and maximum metal precipitation was observed. The mixture was cooled to 10° C., the liquid was decanted, and metals were washed with a 0.5N KOH solution to a pH 7, thereafter dried thoroughly. The dry powder/granules were pressed with a press device, having no less than 10 kg/cm² pressure, to the desired size, e.g., 1 cm³, 2 cm³ and sintered in an oven at 700-900° C. followed by quick cooling under a stream of nitrogen gas.

The following are catalyst compositions prepared according to the processes of the invention:

Catalyst composition 1 consisting of 47% Co⁰, 45% Ni⁰, 5% Cr⁰ and 3% Cr₂O₃.
Catalyst composition 2 consisting of 14% Co⁰, 53% Ni⁰, 5% Cr⁰, 3% Cr₂O₃, 18% Fe⁰, 0.3% Pd⁰, 1% Mn⁰, 2% Mo⁰, 1% V⁰, 1% V₂O₅, 0.2% Cd⁰, 1% Zn⁰ and 0.5% ZnO.
Catalyst composition 3 consisting of 6.5% Co⁰, 85% Ni⁰, 4.9% Cr⁰, 0.6% Zn⁰, 0.5% Fe⁰, 1.5% Mo⁰, 0.5% Mn⁰ and 0.5% V⁰.
Catalyst composition 4 consisting of 10% Co⁰, 85% Ni⁰, 2% Cr₂O₃ and 3% Mo⁰.

### Catalyst Activation:

As some metallic elements may be sensitive to oxidation, particularly when exposed to oxygen, the catalyst may be heated to 150-300° C. and washed with Nitrogen for 20-30 minutes and or activated in the reactor prior to use as follows: In the reaction vessel, the catalyst was exposed to a hydrogen gas flow at a gradient temperature ranging from room temperature to 175-400° C. After 30 minutes at a high temperature, the process was terminated affording an activated catalyst ready for use as disclosed herein.

### Catalyst Reusability:

The catalyst may be reused, namely a quanta of the catalyst used in a first catalytic reaction may be re-used in a second or further catalytic reactions after isolation from the reaction vessel or reactor in which said first catalytic reaction took place.

For example, a catalyst composition consisting of 85% Ni⁰, 10% Co⁰, 2% Cr₂O₃ and 3% Mo⁰ was used for the decomposition of methane at 600-650° C. and generated 4-40% hydrogen (several runs) in the product gas stream, for an extended time up to 2 hours. After the reaction was over, the catalyst was cooled down, and treated with a carbon removing solvent following the procedure below:

Stage 1: approximately 10 gr of carbon coated catalyst were immersed in 250 ml coke removing solution, such as “SASA Tech” product, comprising of toluene, xylene, methyl chloride, an organic dissolving surfactant, and in another case in a water-based carbon removing solution containing phenol, cellosolve, and a water-based surfactant such as a phosphate ester. The resulting solid-liquid solution was stirred for 10 minutes at room temp.

Stage 2: employing a high ultrasonic vibration with ultrasonic corona immersed in the solution, the solution was sonicated for 15-20 minutes.

Stage 3: the solvent was next decanted into a collecting vessel for carbon particles accumulation and separation. The catalyst was treated again with fresh 250 ml dematerialized water, stirred for 10 minutes and the water decanted again.

Stage 4: optionally repeating stage 1.

Stage 5: optionally repeating stages 2 and 3.

At this stage, the decanted water was examined. If it still contained suspended carbon particles, the process was repeated again. Otherwise, stages 6 to 10 were followed.

Stage 6: the solid mass was treated with 250 ml dematerialized water and stirred for 5 minutes. The solid mass was then poured into 2 special centrifuge containers.

Stage 7: the containers were centrifuged at 3,000-4,000 rpm for 5-10 minutes.

Stage 8: the water with the suspended carbon fine particles was decanted from the solid mass which collected at the bottom of the container.

Stage 9: the solid mass was dried under in air circulating oven at 120° C.

Stage 10: the solid mass catalyst was collected in a clean dry glass vessel and placed in a desiccator for storage.

The solid carbon was also treated and collected to calculate the conversion yield and study the decomposition of the hydrocarbon in the presence of the catalyst of the invention.

The above process may be repeated as may be necessary to afford a clean re-usable catalyst. The catalyst may then be re-introduced into the reactor and a further e.g., methane decomposition catalytic reaction may be carried out. Activation of the catalyst followed as necessary.

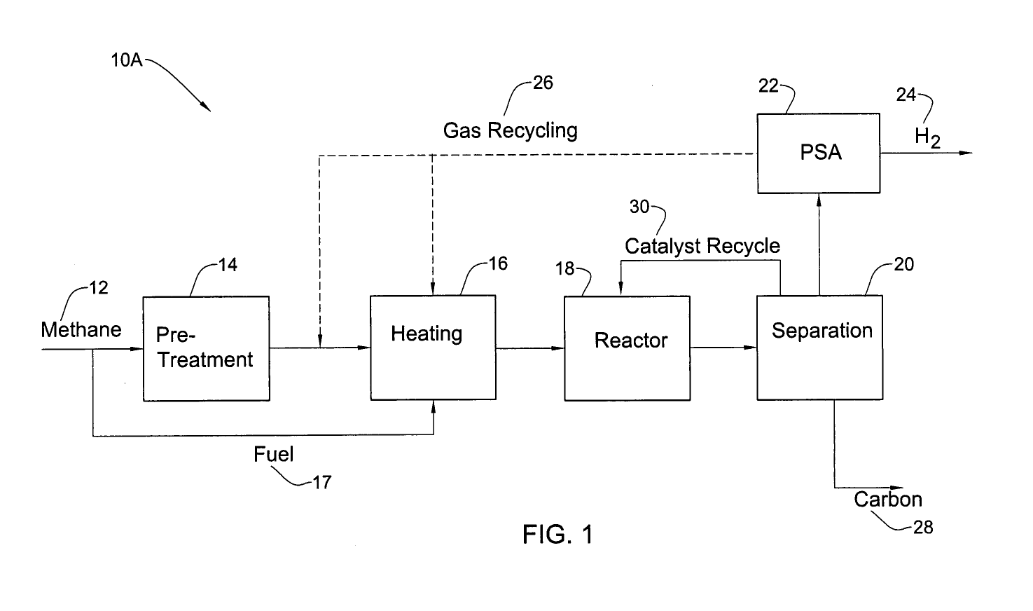

The process disclosed above may be carried out employing a system schematically represented in the block diagram of FIG. 1, where methane gas, as an exemplary gaseous hydrocarbon is catalytically decomposed to produce hydrogen gas (free of carbon dioxide) and solid carbon.

As FIG. 1 demonstrates, in the catalytic process designated 10A, natural gas 12 comprising methane or methane gas (pure or comprising gaseous residues) is pre-treated by drying and/or desulfurization 14 followed by heating 16 the gas employing a heating unit at an optionally preset constant temperature. The heating unit may be by heat exchangers and fueled by natural gas 17 or by any other fuel. The heated gas is then transferred into the reactor 18 which may be in the form of, e.g., a fixed bed, a (vertical) moving bed, a circulating bed or a floating catalytic reactor in which a quantity of the catalyst of the invention is placed. Upon conversion of the catalytic decomposition of the methane gas into solid carbon and hydrogen, the solid carbon collects on the reactor bed and the gases comprising hydrogen gas and non-converted methane gas are then separated 20, for example by employing pressure swing absorber (PSA) 22 or any other separation unit known in the art. The hydrogen gas separated from the gaseous mixture is then recovered 24 and the non-converted methane gas is recycled 26 back into the dried and/or desulfurized natural gas flow.

The catalyst may be regenerated by one or more of the procedures disclosed herein depending on numerous factors having to do for example with the age of the catalyst, the material to be decomposed, the degree of conversion and other factors known to a person skilled in the art. Upon generation and separation of the catalyst from the solid carbon 28, the catalyst may be recycled 30.

In an actual set-up constructed for the purpose of converting a hydrocarbon into hydrogen gas and solid carbon, the system consisted of 4 sections:

1. Gases supply 12, control and monitoring;
2. Heating system 16, control and monitoring;

### 3. The Reactor 18; and

4. Gases sampling and analysis 24.

Gas supply: Methane (as an exemplary gas 12), nitrogen, and hydrogen gases were carried by high pressure (200 bar) cylinders, flowed through 2-stage gas regulators (200-0, 0-50 bar), assembled with pressure indictors. The flow of each gas was controlled by needle valves at precision calibrated Rotameters. N₂ and H₂ rotameters scale: 0-1000 ml/min. CH₄ rotameter: 0-100 ml/min.

The heating system was built by two consecutive sections: heating the feed gas in an oven 16 and heating the reactor 18 inlet and body.

First, the inlet gas was passed through ⅛″ coil tube in BIFA Electrotherm electric programmable oven, with a maximum design temperature at 950° C. Working temperature was 550-675° C. The oven was suited with a full control system, having a precision of 0.5° C.

Second, a controllable Tungsten heating tape extended from the inlet tube along the reactor structure 18, controlled by Watlaw, PID control loop, electrical supply and control system.

Controlling and measuring the temperature was achieved by skin temperature Thermocouple, type K, adjusted to the reactor outside wall facing the catalyst bed.

The reactor 18 employed may be any one of the known reactors in the art. In this process, the reactor was a vertical tubular fixed bed reactor, stainless steel 321. Other high temperature resisting alloy steel built may also be utilized. Catalyst basket, adjusted to the reactor inside diameter was positioned on an inside groove. The basket was made of a metal, with mesh at the bottom to hold the fine layer of a mineral wool acting as a support for the catalyst.

The basket in its configuration may hold 8-15 grams of a catalyst. A thermo well, extending from the reactor top sealing flange, with a thermocouple, was located at the inside of the catalyst bed basket, thus enabling intimate continuous measurement of the catalyst temperature.

Three gas temperature measurements were taken throughout the process: (i) feed gas at the entrance of the reactor, (ii) reactor skin temperature facing the catalyst bed, and (iii) temperature inside the catalyst bed and at direct contact with the catalyst itself.

Gas sampling: a special online H₂ analyzer, with 0.5% reading precision was located at the product gas flow line 24. The analyzer was calibrated and measured H₂ volumetric concentrations. This device was computer connected and activated, for online display and printing.

For selectivity measurements, a 10-micro liter syringe sampler was used to extract samples from a septum at the reactor outlet product line. The samples were injected to a calibrated and computer controlled FID 3800 Varian Gas Chromatograph.

1.-32. (canceled)

33. A catalyst composition comprising at least one metal or metal oxide selected from the group consisting of Co⁰, Ni⁰Cr⁰ and Cr₂O₃, the catalyst being monolithic and non-supported.

34. The composition according to claim 33, further comprising at least one metal or metal oxide selected from the group consisting of Mo⁰, Fe⁰, Mn⁰, MnO₂, Pt⁰, Pd⁰, V⁰, V₂O₅, Cd⁰, Ag⁰, Zn⁰, ZnO, and Cu⁰.

35. The composition according to claim 33, comprising between about 5-60% Co⁰, between about 10-90% Ni⁰, between about 1-45% Cr⁰ and between about 1-45% Cr₂O₃ (w/w).

36. The composition according to claim 35, further comprising at least one metal or metal oxide selected from the group consisting of Mo⁰, Fe⁰, Mn⁰, MnO₂, Pt⁰, Pd⁰, V⁰, V₂O₅, Cd⁰, Ag⁰, Zn⁰, ZnO, and Cu⁰ in an amount ranging from between about 0-20% (w/w).

37. The composition according to claim 35, comprising between about 5-15% Co⁰, between about 15-90% Ni⁰, between about 1-35% Cr⁰, and between about 1-35% Cr₂O₃ (w/w).

38. The composition according to claim 35, comprising between about 5-15% Co⁰, between about 15-90% Ni⁰, between about 1-15% Cr⁰, and between about 1-15% Cr₂O₃ (w/w).

39. The composition according to claim 37, further comprising at least one metal or metal oxide selected from the group consisting of Mo⁰, Fe⁰, Mn⁰, MnO₂, Pt⁰, Pd⁰, V⁰, V₂O₅, Cd⁰, Ag⁰, Zn⁰, ZnO, and Cu⁰ in an amount ranging from between about 0.5-18% (w/w).

40. The composition according to claim 37, comprising at a minimum about 5% Co⁰, at a minimum about 50% Ni⁰, at a minimum about 1% Cr⁰, and at a minimum about 1% Cr₂O₃ (w/w).

41. The composition according to claim 40, further comprising at least one metal or metal oxide selected from the group consisting of Mo⁰, Fe⁰, Mn⁰, MnO₂, Pt⁰, Pd⁰, V⁰, V₂O₅, Cd⁰, Ag⁰, Zn⁰, ZnO, and Cu⁰.

42. The composition according to claim 33, being recyclable.

43. A process for the catalytic transformation of a compound, the process comprising contacting the compound with a catalyst composition according to claim 33, in a reactor under conditions allowing the transformation, thereby obtaining a product.

44. A process according to claim 43, for the catalytic transformation of an organic compound, the transformation being selected from the group consisting of oxidation, hydrogenation, carbonylation, carbon-carbon bond formation, metathesis, decomposition of hydrocarbons and polymerization, and the process comprising contacting the organic compound with a catalyst composition comprising at least one metal or metal oxide selected from the group consisting of Co⁰, Ni⁰Cr⁰ and Cr₂O₃, the catalyst being monolithic and non-supported, in a reactor under conditions allowing the transformation, thereby obtaining a product.

45. The process according to claim 44, for the catalytic decomposition of a hydrocarbon wherein the hydrocarbon is selected from the group of hydrocarbons having between 1 and 15 carbon atoms, the process comprising contacting the hydrocarbon with a catalyst composition comprising at least one metal or metal oxide selected from the group consisting of Co⁰, Ni⁰Cr⁰ and Cr₂O₃, the catalyst being monolithic and non-supported, in a reactor under conditions allowing decomposition, thereby obtaining a product.

46. A process for the catalytic decomposition of methane, the process comprising contacting methane with a catalyst composition according to claim 33, in a reactor under conditions allowing decomposition, thereby obtaining hydrogen gas and solid carbon.

47. The process according to claim 46, optionally further comprising recovering the hydrogen gas and/or solid carbon.

48. The process according to claim 46, further comprising separating the solid carbon from the catalyst composition.

49. The process according to claim 44, wherein the hydrocarbon reactant is brought into contact with the catalyst composition at a temperature of from about 400° C. to about 825° C.

50. The process according to claim 44, wherein the reactor is selected from the group consisting of a fixed bed, a moving bed, a fluidized bed and a circulating catalytic reactor.

51. A process for the production of hydrogen gas, the process comprising reacting a hydrocarbon with a catalyst composition according to claim 33, and allowing the hydrocarbon to decompose into hydrogen.

52. The process according to claim 49, wherein the hydrocarbon is methane.

53. The composition according to claim 38, further comprising at least one metal or metal oxide selected from the group consisting of Mo⁰, Fe⁰, Mn⁰, MnO₂, Pt⁰, Pd⁰, V⁰, V₂O₅, Cd⁰, Ag⁰, Zn⁰, ZnO, and Cu⁰ in an amount ranging from between about 0.5-18% (w/w).
